(19) United States
(12) Patent Application Publication
(10) Pub. No.: US 2018/0232836 A1
(43) Pub. Date: Aug. 16, 2018

(54) METHOD AND DEVICE FOR CARRYING OUT A SCREENING OF PERSONS

(71) Applicant: VERIDOS GMBH, Berlin (DE)

(72) Inventor: Frank Schmalz, München (DE)

(21) Appl. No.: 15/749,752

(22) PCT Filed: Aug. 10, 2016
(86) PCT No.: PCT/EP2016/001372

§ 371 Date: Feb. 1, 2018

(30) Foreign Application Priority Data
Aug. 11, 2015 (DE) 10 2015 010 184.6

(51) Int. Cl. G06Q 50/26; H04W 12/02

(52) U.S. Cl. CPC G06Q 50/265; H04W 4/80; H04W 12/02

(57) ABSTRACT

The present invention relates to a method for carrying out an identity check in a screening corridor (10), in which the individuals (20) to be screened carry, when passing through the screening corridor (10), a mobile apparatus (22) that permits a determination of the position of the individual (20) within the screening corridor (10), the mobile apparatuses (22) of the individuals (20) to be screened transmit to a screening entity (100) in each case via a communication link, as identification data of the individual, the individual's (20) biometric reference values to be checked in each case, the screening entity (100) position-dependently detects, by means of at least one detection device (40), biometric actual values of the individuals (20) to be screened, the positions of the individuals (20) to be screened within the screening corridor (10) are determined with the aid of the mobile apparatuses (22) carried by said individuals, and the screening entity (100) checks for agreement the position-dependently detected biometric actual values and the biometric reference values, relayed by the mobile apparatuses (22), of the individuals (20) located at the respective positions and makes a screening decision regarding the identity of the screened individuals (20) based on the check result.

The present invention relates to a method for carrying out an identity check in a screening corridor, and a screening system for carrying out an identity check with such a method.

Identity checks are normally carried out at boundaries, the boundaries being able to be both sovereign boundaries and procedural boundaries, for example in the case of a passenger screening for a domestic flight, or also boundaries to buildings or grounds. Particularly the steady increase in travelers poses major challenges today for border points worldwide to quickly yet reliably verify the identity of the travelers.

In an identity check, normally an identity document of an individual is checked for authenticity and an identity check of the individual is carried out, for example by comparing an identification photo with the current appearance of the individual. To accelerate the clearance at the screening points and make the detection of the data that identifies the individual as error-free as possible, identity documents were created in which the information identifying the individual, such as biometric characteristics, is developed to be machine-readable.

Current methods for biometric verification normally require an isolation of the individuals to be screened at a screening point in order to then be able to carry out a 1-to-1 check of the detected biometric features with machine-readably stored biometric features. However, the isolation of the individuals and the detection of the biometric features are time-consuming. Also, for a comparison of biometric features, it must be specified in advance with which reference value a detected feature is to be compared.

In checking biometric features, methods are also known that carry out a so-called 1-to-n comparison and compare, for example, a face detected through video recordings with a large number of faces stored in a database. However, the false acceptance rates occurring there, or in other words the acceptance rate of unauthorized individuals, and the false rejection rates, or in other words the rejection rate of authorized individuals, are as yet inadequate for practical use.

Proceeding from this, the object of the present invention is to avoid the disadvantages of the background art and especially to specify a fast and reliable method for carrying out an identity check.

Said object is solved by the features of the independent claims. Developments of the present invention are the subject of the dependent claims.

The present invention provides a method for carrying out an identity check in a screening corridor, in which
the individuals to be screened carry, when passing through the screening corridor, a mobile apparatus that permits a determination of the position of the individual within the screening corridor,
via a communication link, the mobile apparatuses of the individuals to be screened transmit to a screening entity, as identification data of the individual, the individual's biometric reference values to be checked in each case,
the screening entity position-dependently detects, by means of at least one detection device, biometric actual values of the individuals to be screened,
the positions within the screening corridor of the individuals to be screened are determined with the aid of the mobile apparatuses carried by said individuals, and
the screening entity checks for agreement the position-dependently detected biometric actual values and the biometric reference values, relayed by the mobile apparatuses, of the individuals located at the respective positions and makes a screening decision regarding the identity of the screened individuals based on the check result.

In one advantageous method variant, here, the positions of the individuals to be screened are determined by the screening entity, preferably with the aid of signals that are transmitted by the mobile apparatuses of the individuals to be screened. For this, the screening entity advantageously makes use of a plurality of access points that are expediently arranged along both sides of the screening corridor. As soon as multiple access points pick up the signals of a mobile apparatus, they can, for example through triangulation or via the received signal strength of the mobile apparatuses, determine the position of the mobile apparatus within the screening corridor with sufficient accuracy.

In another, likewise advantageous method variant, the mobile apparatus itself of an individual to be screened determines its position within the screening corridor and transmits the determined position via a communication link to the screening entity. Here, the position determination can be done, for example, through DGPS (differential global positioning system), or there can be arranged along the screening corridor small short-range transmitters that transmit characteristic signals and thus enable the mobile apparatuses to determine, via the received signal strength of the transmitters located in range, the position of the apparatus within the screening corridor.

In transmitting the identification data, the mobile apparatus of an individual transmits, as identification data, the individual's biometric reference values to be checked. In principle, however, it is also possible that the identification data constitutes only a reference to the biometric reference values to be checked in a database that is accessible to the screening entity. In that case, the screening entity retrieves the individual's biometric reference values to be checked from the database with the aid of the relayed reference.

The identification data and/or the position data determined by the mobile apparatus are advantageously transmitted to the screening entity via a local mobile network connection, especially WLAN or Bluetooth.

In one advantageous method variant, the identification data is relayed by the mobile apparatus to the screening entity digitally signed. Alternatively, the identification data and/or the position data determined by the mobile apparatus can also be relayed to the screening entity via a secure authentic channel.

The biometric actual values of the individuals to be screened are advantageously detected by means of a plurality of sensors, especially cameras, arranged at defined positions in the screening corridor.

The biometric reference values that are present on the mobile apparatuses and that are to be checked are advantageously generated or certified by an issuing entity that is independent of the screening entity, and are preferably signed by the issuing entity. The issuing entity may be, for example, a government authority. In any case, the issuing entity is different from and independent of the screening entity, such that the biometric values generated or certified by the issuing entity constitute factually independent reference values for the later comparison with the biometric actual values detected by the screening entity.

In one preferred variant of the present invention, the biometric actual values detected for a certain position are checked for agreement with the biometric reference values of all of the individuals located in a specified check field around the certain position. Here, the size of the check field is expediently defined based on the accuracy of the position determination in order not to have to check an unnecessarily large number of individuals. The size of the check field can especially be chosen such that only 5 or fewer, preferably only 3 or fewer check comparisons of detected biometric actual values with the biometric reference values, relayed by the mobile apparatuses, of the individuals located in the check field are required.

The screening entity advantageously makes the screening decision after checking two or more biometric actual and reference values for agreement to ensure a particularly high recognition security.

Especially smartphones or tablet computers can be used as mobile apparatuses.

The present invention also includes a screening system for carrying out an identity check with a method of the kind described above, having
a screening corridor that the individuals to be screened pass through for the identity check,
at least one detection device for position-dependently detecting biometric actual values of the individuals to be screened, and
a screening entity that is designed and set up
   to receive, via a communication link, as identification data of the individuals to be screened, the individual's biometric reference values to be checked,
   to receive or to determine positions within the screening corridor of the individuals to be screened, and
   to check for agreement position-dependently detected biometric actual values and received biometric reference values of the individuals located at the respective positions and to make a screening decision regarding the identity of the screened individuals based on the check result.

The screening system preferably further includes a plurality of access points for the determination of the positions within the screening corridor of the individuals to be screened. In one advantageous variant of the present invention, the access points are designed and set up to receive signals transmitted by mobile apparatuses of the individuals to be screened and, based on the received signals, to determine the positions of the mobile apparatuses within the screening corridor. In another, likewise advantageous variant of the present invention, the access points are developed to be short-range transmitters for transmitting characteristic signals that permit mobile apparatuses of the individuals to be screened to determine their position in each case within the screening corridor.

The screening entity can especially be designed and set up to check the biometric actual values detected for a certain position for agreement with the biometric reference values of all of the individuals located around the certain position in a specified check field, the size of the check field preferably being defined based on the accuracy of the position determination.

Further exemplary embodiments and advantages of the present invention are explained below by reference to the drawings, in which a depiction to scale and proportion was dispensed with in order to improve their clarity.

Shown are:

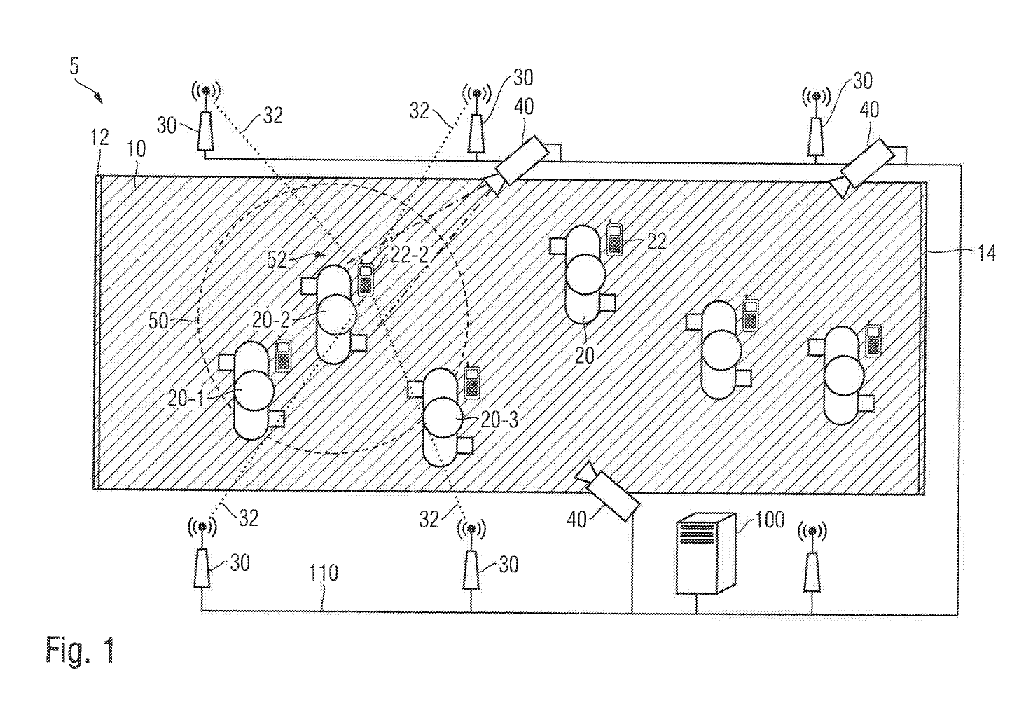

FIG. 1 a schematic diagram of a screening system according to an exemplary embodiment of the present invention,

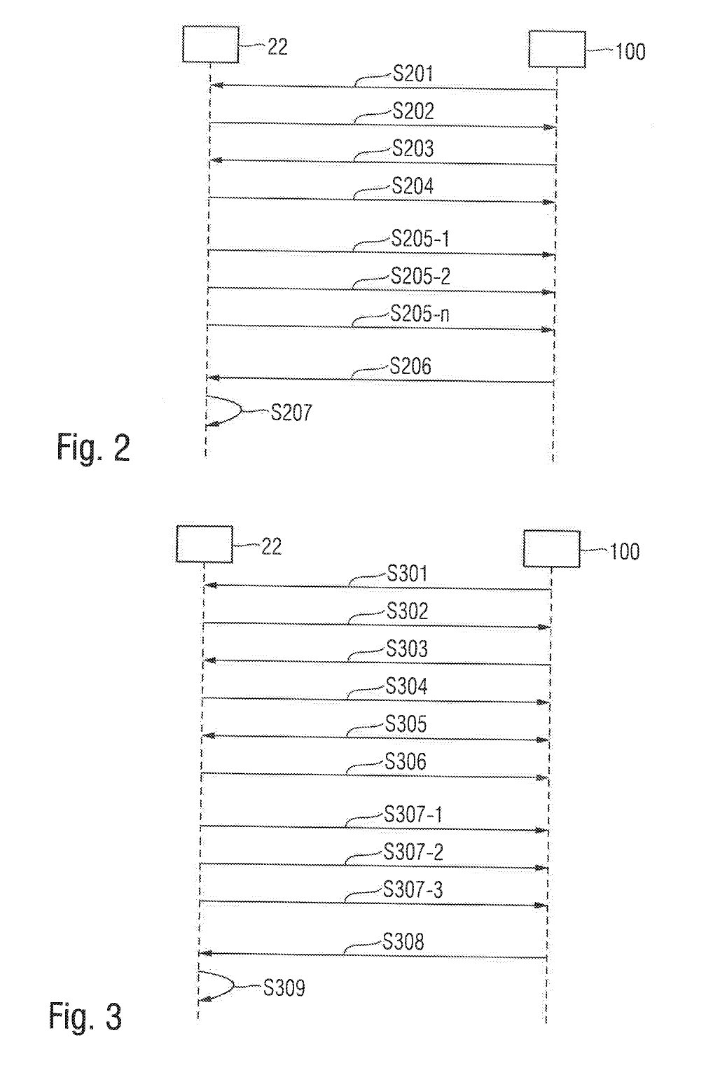

FIG. 2 a diagram of the sequence of the communication between the mobile apparatus of an individual to be screened and a screening system in a method according to the present invention, and

FIG. 3 a diagram of the sequence of the communication between the mobile apparatus of an individual to be screened and a screening system according to another method according to the present invention.

To further explain the present invention, FIG. 1 shows an inventive screening system 5 that includes, as a central component, a screening corridor 10 that individuals 20 to be screened pass through from an entry 12 to an exit 14, for example after leaving an arriving aircraft. The entry and exit of the screening corridor 10 may, but need not necessarily, be recognizable as such for the individuals to be screened. The identity check occurs substantially automatically upon passing through the screening corridor 10 and without the need for an isolation of the individuals 20 to be screened. In this way, delays can be avoided and a high throughput achieved for the identity check.

The identity check is managed by a screening entity 100 that is connected with a series of access points 30 and a series of biometric detection devices 40, which are each arranged along both sides of the screening corridor 10. In the exemplary embodiment, the screening entity 100 is connected with the access points 30 and the detection devices 40 by cable using a LAN 110, but in other embodiments, it can also be connected by a wireless transmission method.

When passing through the screening corridor 10, the individuals 20 to be screened each carry a mobile apparatus 22, for example in the form of a smartphone on which an identification application is installed. The identification application is activated upon entering the screening corridor 10 at the entry 12 and, to protect the privacy of the individuals 20, is deactivated again upon leaving the screening corridor at the exit 14. The activation and deactivation is preferably done by the screening entity 100 without a user action being required.

Following the activation of the identification application, the mobile apparatus 22-2 of an individual 20-2 relays, via a communication link, identification data of said individual 20-2 to the screening entity 100. The identification data may be biometric reference values of the individual in question that are to be checked and that are stored on the apparatus 22-2, or also a pointer to such biometric reference values in a database that is accessible to the screening entity 100. For example, travelers may be registered with a program for easier entry in which the biometric reference values of the travelers are stored in advance in a database from which they can be retrieved by the screening entity 100 for the identity check.

After the receipt of the biometric reference values from the apparatus 22-2 or the search of a database, the screening entity 100 has access to the biometric reference values of the individual 20-2 to be screened.

To ensure the authenticity of the identification data, said data can be relayed by the apparatus 22-2 to the screening entity 100 digitally signed, or a secure authentic channel can be set up between the screening entity 100 and the apparatus 22-2 for the relaying of the identification data.

While the individuals 20 to be screened pass through the screening corridor 10, biometric actual values of the individuals 20 are continuously position-dependently detected by the biometric detection devices 40. The detected biometric features may be, for example, iris and retina structure, hand vein structure, facial geometry, movement patterns and the like.

In addition, the positions within the screening corridor 10 of the individuals 20 to be screened are determined with the aid of the mobile apparatuses 22 carried by said individuals. This can occur, for example, in that the access points 30 receive signals 32 transmitted by the mobile apparatuses 22 and determine their position within the corridor 10 through triangulation.

Alternatively, the identification application of a mobile apparatus 22 can itself determine the position of the apparatus within the screening corridor 10 and transmit the determined position to the screening entity 100 via a communication link. For example, the access points 30 can be developed to be short-range transmitters that transmit characteristic signals. The identification application of a mobile apparatus 22 can identify the transmitter in its range, determine the distance of the apparatus 22 from the short-range transmitters 30 using the received signal strength, and determine the position of the apparatus 22 in the screening corridor 10 by trilateration.

In both variants, after the position determination, the screening entity 100 has access to the positions of the individuals 20 within the screening corridor 10.

With said position information, the screening entity 100 can now check the position-dependently detected biometric actual and the relayed biometric reference values of the individuals located at the respective positions 20 for agreement. In the ideal case, only one individual 20-2 with its detected biometric actual values is located at a determined position. In this case, can the screening entity 100 can check the identity of the individual 20-2 through a 1-to-1 comparison of the detected biometric actual values with the transmitted biometric reference values and make a screening decision regarding the identity of the screened individual 20-2 based on the check result. For example, in the event of a successful identity check, the individual 20-2 can leave the screening corridor 10 without further interaction, while in the event of a failed identity check, they are flagged down and checked by screening personnel in the conventional manner.

Since the detected biometric actual values do not always have adequate quality for a successful identity check, for example because an individual 20-2 is just turning away from the detection device 40 at a certain time, moves too quickly for the detection or is hidden by another individual, multiple detection and check attempts are undertaken while an individual 20-2 is passing through the screening corridor 10. An intervention by human screening personnel at the exit 14 is required only when no successful identity check is managed throughout the entire distance of the screening corridor 10.

Especially when a large number of individuals to be screened pass through the screening corridor 10 simultaneously, it is possible that also more than one individual is in the immediate vicinity of a determined position. Within the scope of the present invention, this fact is accommodated in that, for example, the check for agreement of the biometric values is carried out within a certain radius of a determined position. For this, depending on the accuracy of the position determination, for each position, a check field 50 of a certain size is defined, for example the check field 50 can extend with a radius of 2 meters about a determined position, as shown in FIG. 1.

For the agreement check, the biometric actual values detected for a certain position 52 are then checked for agreement with the biometric reference values of all individuals 20-1, 20-2 and 20-3 located in the check field 50. Due to the relatively high accuracy of the position determination, typically only a few individuals are located in a check field 50, such that only a small number of check comparisons, typically 5 or fewer, usually even only 3 or fewer are required. This represents a significant improvement compared with conventional 1-to-n comparison scenarios in which the detected biometric actual values of an individual must usually be compared with thousands or tens of thousands of biometric reference values.

At the exit 14 of the screening corridor 10, now only those individuals 20 for whom no successful identity check was managed in the screening corridor 10 must be screened more closely. To differentiate the individuals 20 with a successful or failed identity check, one can refer to the positions of the successfully screened individuals 20, which are known to the screening entity 100 due to the continuous position determination up to the exit 14. The mobile apparatuses 22 of successfully identified individuals 20 can also receive and display a corresponding confirmation notification from the screening entity 100.

FIG. 2 illustrates the sequence of the communication between the mobile apparatus 22 of an individual 20 to be screened and the screening system 100 in one exemplary embodiment of a method according to the present invention.

In step S201, the identification application of the mobile apparatus 22 is activated. In step S202, the mobile apparatus 22 registers with the screening entity 100, initially anonymously, and in step S203, said entity authenticates itself to the mobile apparatus 22.

After the mobile apparatus 22 has recognized the screening entity 100 as trustworthy due to the authentication, it transmits, in step S204, the stored, digitally signed biometric reference values of the individual 20 to the screening entity 100.

In steps S205-1, S205-2 to S205-n, the mobile apparatus 22 continuously determines its position within the screening corridor 10, for example through trilateration as described above, and transmits the position determined in each case to the screening entity 100. Said position determination is repeated until the individual 20 leaves the screening corridor 10 at the exit 14. In the event of a successful identification, the screening entity 100 confirms this to the mobile apparatus 22 in step S206 and notifies it of the end of the corridor. The mobile apparatus 22 subsequently ends the transmission in step S207.

In the alternative method illustrated in FIG. 3, for security reasons, no digitally signed data record is transmitted by the mobile apparatus 22, but rather a secure authentic channel is established between the screening entity 100 and the mobile apparatus 22 for the transmission of the biometric reference values.

More precisely, for this, the identification application of the mobile apparatus 22 is activated by the screening entity 100 in step S301. In step S302, the mobile apparatus 22 registers with the screening entity 100, initially anonymously, and in step S303, said entity authenticates itself to the mobile apparatus 22. In step S304, the mobile apparatus 22, for its part, authenticates itself to the screening entity 100, and in step S305, a secure authentic transmission channel is established based on said mutual authentication.

In step S306, the mobile apparatus 22 now transmits the stored biometric reference values of the individual 20 to the screening entity 100 via the secure authentic transmission channel.

The further method proceeds substantially as in the exemplary embodiment in FIG. 2. In steps S307-1, S307-2 to S307-n, the mobile apparatus 22 continuously determines its position within the screening corridor 10 and transmits the position determined in each case to the screening entity 100 via the secure transmission channel. Said position determination is repeated until the individual 20 leaves the screening corridor 10 at the exit 14. In the event of a successful identification, the screening entity 100 confirms this to the mobile apparatus 22 in step S308 and notifies it of the end of the corridor. The mobile apparatus 22 subsequently ends the transmission in step S307.

According to one variant, the mobile apparatus can, of course, also be an RFID tag, especially a UHF tag, that is developed to transmit over a short distance (e.g. 3-6 m).

1. A method for carrying out an identity check in a screening corridor, in which
the individuals to be screened carry, when passing through the screening corridor, a mobile apparatus that permits a determination of the position of the individual within the screening corridor,
via a communication link, the mobile apparatuses of the individuals to be screened transmit to a screening entity, as identification data of the individual, the individual's biometric reference values to be verified in each case,
the screening entity position-dependently detects, by means of at least one detection device, biometric actual values of the individuals to be screened,
the positions within the screening corridor of the individuals to be screened are determined with the aid of the mobile apparatuses carried by said individuals, and
the screening entity checks for agreement the position-dependently detected biometric actual values and the biometric reference values, relayed by the mobile apparatuses, of the individuals located at the respective positions and makes a screening decision regarding the identity of the screened individuals based on the check result.

2. The method according to claim 1, characterized in that the screening entity determines the positions of the individuals to be screened, preferably with the aid of signals transmitted by the mobile apparatuses, or in that the mobile apparatus of an individual to be screened determines its position within the screening corridor and relays the determined position to the screening entity via a communication link.

3. The method according to claim 1, characterized in that the identification data and/or the position data determined by the mobile apparatus are transmitted to the screening entity via a local mobile network connection, especially WLAN or Bluetooth.

4. The method according to claim 1, characterized in that the identification data is transmitted by the mobile apparatus to the screening entity digitally signed.

5. The method according to claim 1, characterized in that the identification data and/or the position data determined by the mobile apparatus are transmitted to the screening entity via a secure authentic channel.

6. The method according to claim 1, characterized in that the biometric actual values of the individuals to be screened are detected by means of a plurality of cameras arranged at defined positions in the screening corridor.

7. The method according to claim 1, characterized in that the biometric reference values that are present on the mobile apparatuses and that are to be checked are generated or certified by an issuing entity that is independent of the screening entity, and are preferably signed by the issuing entity.

8. The method according to claim 1, characterized in that the biometric actual values detected for a certain position are checked for agreement with the biometric reference values of all the individuals located around the certain position in a specified check field, the size of the check field preferably being defined based on the accuracy of the position determination.

9. The method according to claim 8, characterized in that the size of the check field is chosen such that only 5 or fewer, preferably only 3 or fewer check comparisons of detected biometric actual values with the biometric reference values, relayed by the mobile apparatuses, of the individuals located in the check field are required.

10. The method according to claim 1, characterized in that the screening entity makes the screening decision after checking two or more biometric actual and reference values for agreement.

11. The method according to claim 1, characterized in that smartphones or tablet computers are used as mobile apparatuses.

12. A screening system for carrying out an identity check with a method according to claim 1, having
screening corridor that the individuals to be screened pass through for the identity check,
at least one detection device for position-dependently detecting biometric actual values of the individuals to be screened, and
a screening entity that is designed and set up
to receive via a communication link, as identification data of the individuals to be screened, the individual's biometric reference values to be checked,
to receive or to determine positions within the screening corridor of the individuals to be screened, and
to check for agreement position-dependently detected biometric actual values and received biometric reference values of the individuals located at the respective positions and to make a screening decision regarding the identity of the screened individuals based on the check result.

13. The screening system according to claim 12, characterized in that the screening system includes a plurality of access points for the determination of the positions within the screening corridor of the individuals to be screened.

14. The screening system according to claim 13, characterized in that the access points are designed and set up to receive signals transmitted by mobile apparatuses of the individuals to be screened and, based on the received signals, to determine the positions of the mobile apparatuses within the screening corridor.

15. The screening system according to claim 13, characterized in that the access points are developed to be short-range transmitters for transmitting characteristic signals that permit mobile apparatuses of the individuals to be screened to determine their position in each case within the screening corridor.

16. The screening system according to claim 12, characterized in that the screening entity is designed and set up to check the biometric actual values detected for a certain position with the biometric reference values of all the individuals located around the certain position in a specified check field for agreement, the size of the check field preferably being defined based on the accuracy of the position determination.
